(19) United States
(12) Patent Application Publication
(10) Pub. No.: US 2013/0318393 A1
(43) Pub. Date: Nov. 28, 2013

(54) SOLID-STATE MASS STORAGE DEVICE AND METHODS OF OPERATION

(71) Applicant: OCZ Technology Group Inc., (US)

(72) Inventors: Wade Tuma, Reno, NV (US); Somayajulu S.K. Pullela, San Jose, CA (US)

(73) Assignee: OCZ TECHNOLOGY GROUP INC., San Jose, CA (US)

(21) Appl. No.: 13/677,900

(22) Filed: Nov. 15, 2012

Related U.S. Application Data
(60) Provisional application No. 61/559,944, filed on Nov. 15, 2011.

(51) Int. Cl. G06F 11/10

(52) U.S. Cl. CPC G06F 11/10
USPC 714/15

(57) ABSTRACT

A volatile memory-based solid-state mass storage device adapted for use in a host system as a storage tier. The storage device includes a substrate on which is mounted a system interface, a control circuitry, and a plurality of substantially identical random access memory components that define at least one memory array. Each memory component of the memory array has associated therewith an input/output path, a width of the input/output path, and a burst length. The storage device is connected to the host system and uses parity information to provide redundancy data sufficient to correct a catastrophic failure of one of the memory components. The number of correctable bits to correct the catastrophic failure of one of the memory components equals the product of the width of the input/output path thereof and the burst length thereof.

### CROSS REFERENCE TO RELATED APPLICATIONS

This application claims the benefit of U.S. Provisional Application No. 61/559,944, filed Nov. 15, 2011, the contents of which are incorporated herein by reference.

### BACKGROUND OF THE INVENTION

The present invention generally relates mass storage devices adapted for use with personal computers, servers, or other host systems. Specifically, the current invention discloses a volatile memory-based mass storage device that uses DDR (double data rate) SDRAM (synchronous dynamic random access memory) memory devices running at a low frequency while providing error correction to allow for failure of an entire memory device.

Computers (including personal computers, servers, and other host systems) have evolved to the point where there is an increasing mismatch between the non-volatile storage of a computer and its combined processing power and memory system (comprising system memory). Generally, the non-volatile storage (or mass storage media) of a computer includes at least one tier of storage comprising non-volatile memory technology in the form of one or more hard disk drives (HDD) and/or solid state drives (SSD), which can be connected to the motherboard of the computer using conventional Serial ATA (SATA) or serially attached SCSI (SAS) interfaces or else directly plugged into an expansion slot of the motherboard using PCIe (PCI (peripheral component interconnect) Express) or similar protocols. The combined processing power and memory system of a computer generally encompasses its central processing unit (CPU), including various cache levels, and a graphics processing unit (GPU), including a local frame buffer (LFB). Access latencies and transfer rates of system memory vs. non-volatile storage differ by several orders of magnitude. For example, modern system memory made up of SDRAM (synchronous dynamic random access memory) integrated circuit (IC) components may have initial access latencies of under 50 nano seconds (nsec), whereas flight time between the request and the actual reading of data from drives of the mass storage media is generally measured in milli seconds (msec). It would, therefore, be desirable to store all data in system memory to grant the processor the fastest possible access.

System memory consumes a substantial amount of power. In addition, data in the system memory need to be refreshed on average every 64 msec, which means that after a refresh interval (tREF) the charges of each capacitor comprising an SDRAM memory cell need to be read into the sense amplifier, amplified and then written back to the cell of origin. With increasing memory density, the refresh, during which time no data can be accessed, takes an increasing amount of overhead within the entire operational budget of system memory. Even though burst refreshes of several rows and other countermeasures may be taken, it becomes un-economic to increase the memory space beyond a certain capacity.

In addition, even though error checking and correction (ECC) algorithms have been implemented on system memory, especially in servers, most memory systems are only capable of correcting single bit errors. On the contrary, if an entire memory IC component with, for example, an 8-bit wide I/O path fails, the result will be catastrophic failure of the system.

Non-volatile memory solutions, including but not limited to NAND flash-based SSDs, embrace a substantially lower cost per bit and have implemented more sophisticated error correction schemes, including low density parity check (LDPC) or Bose-Ray-Chaudhuri-Hocquenghem (BCH). Moreover, the power envelope is substantially below that of DRAM. However, as discussed above, access latencies and bandwidth are orders of magnitude higher than those in DRAM systems.

In view of the above, it would be desirable to have an intermediate storage tier with lower power consumption than that of conventional system memory made up of SDRAM, and better access time and bandwidth than that of non-volatile memory, including NAND flash-based SSDs, while providing the necessary fail-over to compensate for multi-bit errors up to failure of an entire memory IC.

### BRIEF DESCRIPTION OF THE INVENTION

The present invention provides volatile memory-based solid-state mass storage devices adapted for use in a host system as a storage tier that has lower power consumption than that of conventional system memory made up of volatile memory-based IC components, and is capable of faster access times and bandwidths than that of a non-volatile memory-based mass storage device.

According to a first aspect of the invention, the mass storage device comprises a substrate on which is mounted a system interface, a control circuitry, and a plurality of substantially identical random access memory components that define at least one memory array. Each of the memory components of the memory array has associated therewith an input/output path, a width of the input/output path, and a burst length. The mass storage device further comprises means that uses parity information to provide redundancy data sufficient to correct a catastrophic failure of one of the memory components of the memory array. The number of correctable bits to correct the catastrophic failure of one of the memory components equals the product of the width of the input/output path thereof and the burst length thereof.

According to a second aspect of the invention, a method is provided for storing and accessing data from a host computer. The method comprises connecting to the host system a mass storage device that comprises a substrate on which is mounted a system interface, a control circuitry, and a plurality of substantially identical random access memory components that define at least one memory array. Each of the memory components of the memory array has associated therewith an input/output path, a width of the input/output path, and a burst length. Parity information is used to provide redundancy data sufficient to correct a catastrophic failure of one of the memory components of the memory array. The number of correctable bits to correct the catastrophic failure of one of the memory components equals the product of the width of the input/output path thereof and the burst length thereof.

According to a third aspect of the invention, a solid-state mass storage device is provided that is adapted for use in a computer system and for storing data thereof. The storage device includes a substrate on which is mounted a system interface, a control circuitry, and a plurality of substantially identical random access memory components organized in ranks that define at least one memory array. Each of the memory components of the memory array has associated therewith an input/output path, a width of the input/output path, and a burst length. The storage device uses sets of data equaling in size the product of the number of memory components, the input/output width of the memory components, and the burst length of the memory components. The sum of bits of a single transfer of data from a single I/O of each memory comprises a subset of data including redundancy data. The redundancy data are sufficient to correct a catastrophic failure of one of the memory components of the memory array, and a number of correctable bits to correct the catastrophic failure of one of the memory components equals the product of the width of the input/output path thereof and the burst length thereof.

The following describe certain additional and preferred but nonlimiting aspects of the invention.

A particular approach that can be implemented with the invention is for each I/O pad of each memory IC component to have its own data trace to the control circuitry and all memory IC components burst data substantially simultaneous. Another approach entails configuring the entire storage device to comprise ranks of memory IC components, wherein each rank bursts a certain number of transfers. As an example, the mass storage device may use seventy-two individual 8-bits wide (×8) DDR3 SDRAM devices as the memory IC components. In this example, the entire storage device can be configured as eight ranks of nine (8 data+1 parity) ×8 memory IC components, wherein each rank bursts eight transfers. All eight ranks are placed on a multi-drop bus and are accessed sequentially by rank-switching on a single read or write request for a combined transfer of an entire sector of 512 Bytes plus parity information for every read or write. In order to achieve chip-fail correction, the data are rearranged such that each quad-word (64 bits) constitutes a single transfer at one I/O pin of each of the seventy-two memory IC components wherein the additional eight bits are used for parity information.

Low frequency operation of the memory IC components used in the storage device can be achieved by turning off an internal digital delay lock loop (DLL) built into DDR-SDRAM IC components and synchronizing data to strobe signals only.

A function of the control circuitry is to perform logical re-arrangement of data stored by the storage device. Suitable control circuitry for this purpose include, but are not limited to, custom field-programmable gate arrays (FPGAs) and custom application specific integrated circuits (ASICs) configured as a state machine. For example, an array of latches of an FPGA can be arranged into different domains and accessed in a time-multiplexed manner over a common I/O bus. The common I/O bus can be configured as a multi-drop bus for the different ranks of memory IC components and also for the different domains of latches in the FPGA. Alternatively, the FPGA can switch internally between the different domains. In preferred embodiments, any quad word including parity information is composed of data of the same I/O pin (DQ) of each memory IC component and the same transfer within the burst.

The I/Os of the memory IC components can be scrambled so that one bit of any one of the eight I/Os of the each memory IC component contributes to the quad word, and wherein only a single bit from each memory IC component is part of the quad word. Individual transfers within a burst sequence can be logically scrambled to constitute the quad word using a single bit from each memory IC component for each quad word. Scrambling of both I/Os and burst sequences can be employed, yet data are still arranged such that only a single bit from each memory IC component is part of the quad word. Chip-fail redundancy for the storage device can be achieved by recombining the individual data I/Os in a manner to utilize a single bit from each one of a plurality of substantially identical memory IC components, forming a logical array for a transfer of any quad word including its error checking and correction (ECC) values.

Other aspects and advantages of this invention will be better appreciated from the following detailed description.

### BRIEF DESCRIPTION OF THE DRAWINGS

FIG. 1 shows the physical layout of an exemplary embodiment of a SDRAM-based solid state drive (SSD) having a serially attached SCSI (SAS) form factor, control circuitry (FPGA), voltage regulator modules, and a memory space made up of thirty-six DDR-SDRAM memory IC components on each side of the drive for a total of seventy-two memory IC components.

FIG. 2 shows the I/O and differential clock and strobe pin-out of a typical DDR3 SDRAM in a ×8 configuration that can be used as a memory IC component for the drive of FIG. 1.

FIG. 3 shows a functional/timing diagram of the drive of FIG. 1 having all data traces of each memory IC component connected separately to an array of latches of the control circuitry.

FIG. 4 represents a preferred embodiment of the drive of FIG. 1, in which the memory space is divided into eight ranks that sequentially burst to different domains in the control circuitry latch array wherein, after completion of the entire sector transfer, the data are logically rearranged into coherent quad words with parity information.

FIG. 5 shows a functional schematic of the clock domain uncoupling through shadowing of data in duplicated (command and data) buffers.

### DETAILED DESCRIPTION OF THE INVENTION

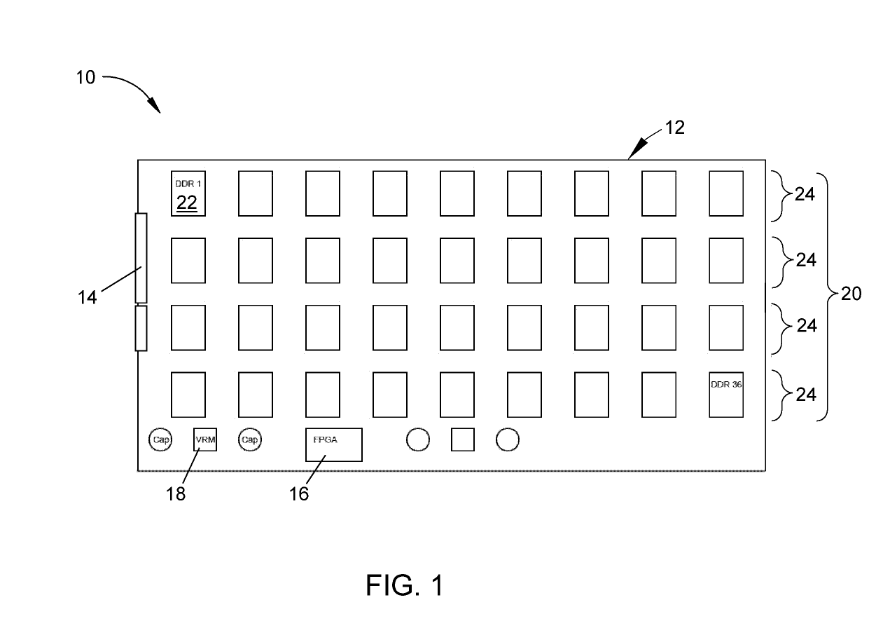

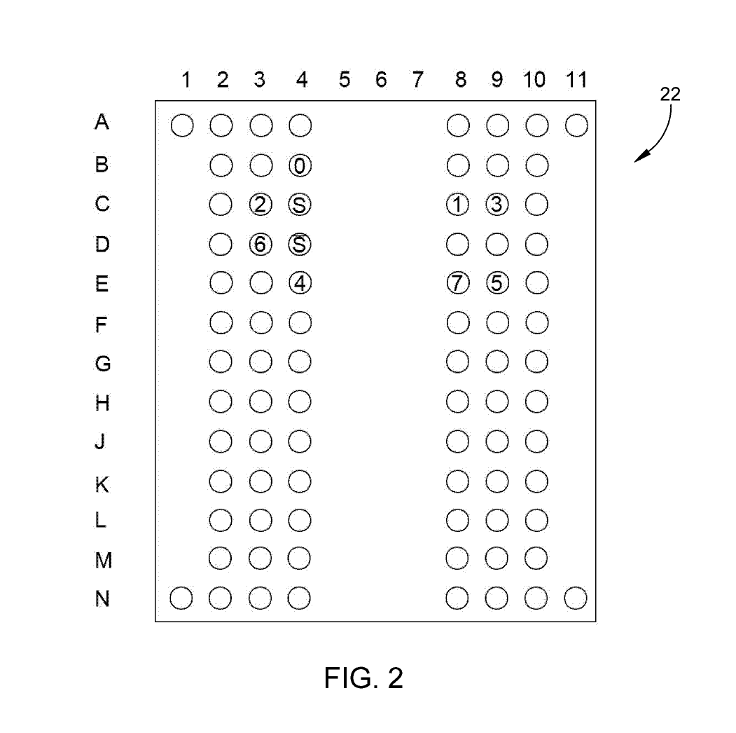

The present invention relates to solid-state mass storage devices suitable for use in host systems (including personal computers, servers, etc.), and more specifically to a mass storage system that makes use of a volatile memory-based mass storage device. In the past, this kind of storage device has faced the challenges of extreme cost of acquisition along with a power budget that negated the benefits of such a device. As a compromise, so-called RAM drives were established as partitions of the system memory space. In contrast, FIG. 1 schematically represents a nonlimiting example of a volatile memory-based mass storage device 10 configured as a DRAM-based solid state drive (SSD). The physical layout of the storage device 10 includes a printed circuit board (or other suitable substrate) 12 and SATA/SAS interface (connector) 14 providing a SAS form factor. The embodiment of the storage device 10 is further represented as comprising a control circuitry 16, voltage regulator modules (VRM) 18, and a memory space made up of a memory array 20 of DDR3-SDRAM IC components 22 (only one of which is labeled). The array 20 preferably contains thirty-six memory IC components 22 on each of two sides of the circuit board 12 for a total of seventy-two memory IC components 22 contained by the array 20 on the storage device 10. FIG. 2 represents an I/O and differential clock and strobe pin-out for one of the components 22 in a ×8 configuration. Exemplary but non-limiting examples of system interfaces suitable as the interface 14 for the storage device 10 include a PCIe edge connector, a SATA/SAS compliant cable interface, or a fiber channel, though any other suitable interface could be used. Power can be supplied to the storage device 10 via the interface 14 or a dedicated power supply line. The VRM 18 convert power to the desired voltage for the memory IC components 22 and control circuitry 16, which may supply a fixed voltage or a dynamically changing supply voltage that depends on load.

The control circuitry 16 is labeled in FIG. 1 as an FPGA, though an ASIC could be used. In either case, the FPGA or ASIC would be configured as a state machine. According to a preferred aspect of the invention, the control circuitry 16 operates as a means on the storage device 10 that is adapted to use parity information to provide redundancy data sufficient to correct a catastrophic failure of one of the memory IC components 22 of the memory array 20, namely, the control circuitry 16 is electrically connected with the memory IC components 22 in such manner that the data transferred in one burst of all memory IC components 22 are rearranged to form subsets of data comprising one bit originating from each IC component 22 for each redundancy-protected unit of data. Accordingly, catastrophic failure of one entire memory IC component 22 would only affect a single bit in each redundancy-protected unit of data. The control circuitry 16 contains buffers or latches for temporary buffering of the data and logic to distribute data on a write access so that each bit of a redundancy-protected unit of data is written to a separate one of the memory components 22. On a read access, the logic reassembles the data according to the same distribution pattern used on a write access to form a redundancy-protected unit of data.

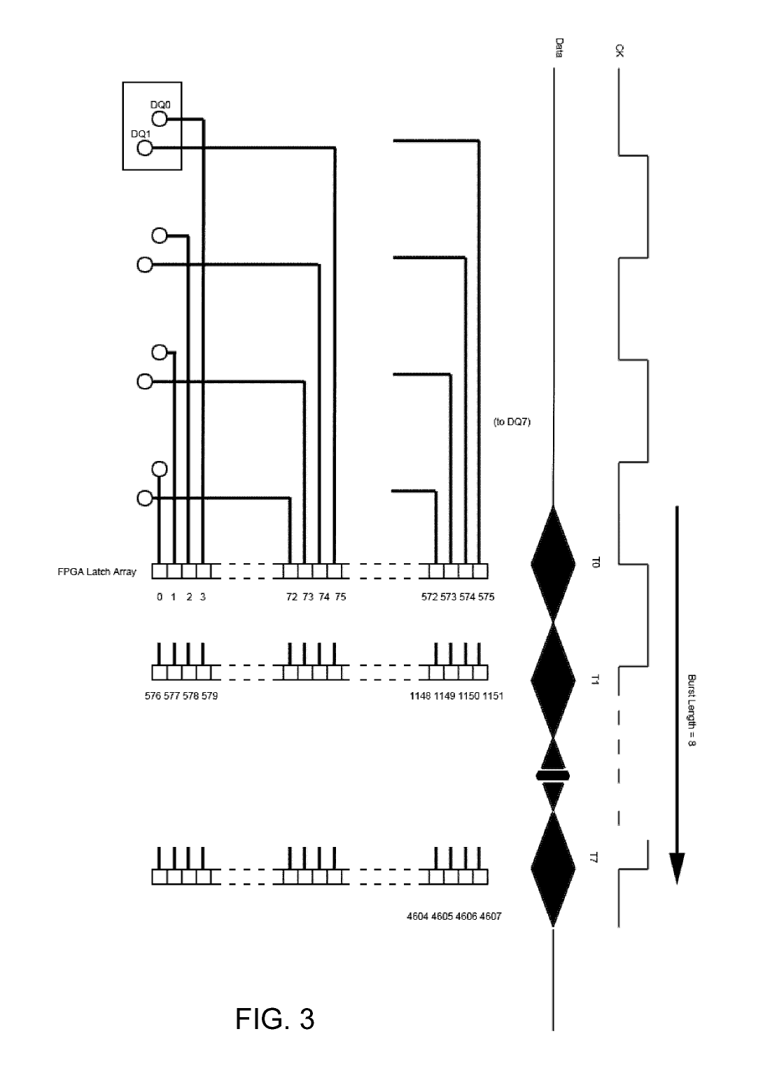

In a first embodiment of the invention, each of the seventy-two memory IC components 22 has its own I/O path to the control circuitry 16, while address and command lines are shared. FIG. 3 shows a functional/timing diagram of such an embodiment of the storage device 10 having all data traces of each memory IC component 22 connected separately to an array of latches of the control circuitry 16. Consequently, all of the memory IC component 22 are treated as being within a single rank, such that each data transfer results in 576 bits being transferred substantially simultaneously wherein typically a per Byte data strobe is implemented for source-synchronous clocking. In this case, a complete sector transfer of 576 Bytes (512 Bytes+64 Bytes ECC) can be accomplished within four clocks at a double data rate protocol resulting in 8 transfers (T0-T7), as represented in FIG. 3. It is appreciated that the routing of 576 discrete data traces (DQs) to a controller poses a considerable implementation challenge, and that this scheme would require the same number of I/O pins on the memory controller. In addition, simultaneous operation of all of the DRAM memory IC components 22 or, in the case of a write operation, driving all data over the massively parallel bus would generate an unacceptable peak power consumption. Even so, at least from a conceptual point of view the embodiment of FIG. 3 is conceptually easy to understand and therefore provides a useful working model for disclosing and discussing various aspects of the invention.

During a read from the component 22, one I/O (DQ) pin of each memory IC component 22 outputs a single bit of a data set to the bus connecting the component 22 to its memory controller. Each data set constitutes a 72-bit transfer using standard ECC algorithms like Hamming code-based parity information wherein no memory IC component 22 contributes more than a single bit. Because of this data arrangement, even the complete failure of any single memory IC component 22 can be corrected. Since the embodiment of FIGS. 1 and 2 utilizes memory IC components 22 having an 8-bit wide I/O path, eight transfers of 8 Bytes+Parity Information are concurring. Because the IC components 22 are agnostic with respect to the order of DQ pins, it is not necessary to maintain the same order of pin-out across all components 22; rather, DQs can be mixed as long as only one DQ per memory IC component 22 contributes to a 72-bit data set. For example, it is possible to use DQ0 of the first memory IC component 22, DQ1 of the second memory IC component 22, and so on. Also, it is possible to use DQ0 of all IC components 22 of a first of the ranks 24 and then DQ1 of all memory IC components 22 of a second rank 24. Any permutation and combination of these examples is possible as long as the data can be remapped to warrant a single bit per component 22 contributing to a quad word (64 bits).

At the control circuitry 16, all data are latched into a 512 Bytes (plus parity information) wide array of latches of the control circuitry 16. The entire sector is transferred as a burst of eight transactions (T0-T7) according to the DDR3 burst protocol. For the host system, the latch array can use virtual addressing. Consequently, data can be scrambled not only with respect to the DQ numbers of the memory IC component 22, but also across the burst in that a seventy-two bit data set may contain data from different transactions within the burst, as long as the above mentioned limitation of no more than a single bit read from or written to each memory IC component 22 is satisfied.

As previously noted, FIG. 3 represents an embodiment of the invention that is functionally easy to understand, but with drawbacks concerning peak power consumption, trace routing on the circuit board 12, and pin count on the controller. While it is conceptually easier to have all memory IC components 22 in a single rank, this “super-wide array” causes some major difficulties with respect to trace routing and peak power management. Accordingly, in preferred embodiments of the invention the memory IC components 22 are segmented into discrete ranks 24 of IC components 22, for example, eight discrete ranks 24 of nine memory IC components 22 represented in the embodiment of FIG. 1, with four ranks 24 located on each side of the circuit board 12 resulting in a 72-bit width. All of the ranks 24 share the same data traces over a multi-drop bus to the controller. Rank switching is accomplished by using the chip-select signal to turn “on” each rank 24 at the appropriate time slice. At the controller, the array of latches of the control circuitry 16 is segmented into eight domains corresponding to the different rank time slices and having eight sub-domains each for accommodating the individual transfers of each data burst.

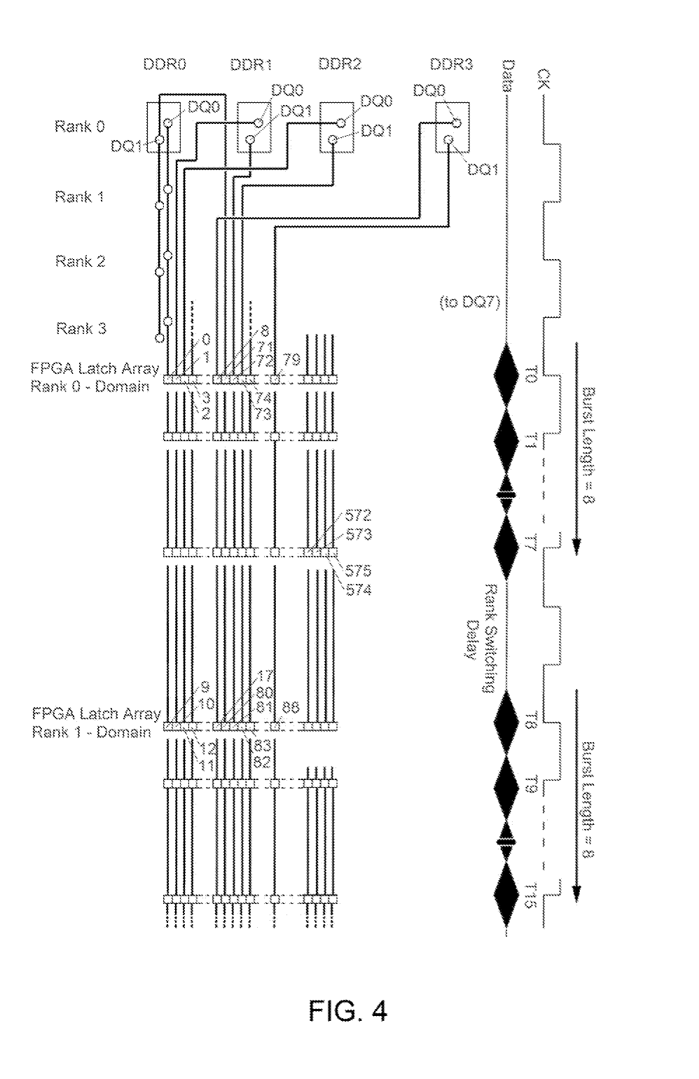

Each transfer of a sector starts with a burst of eight transfers of a single rank 24, as shown in FIG. 4. From this first burst, a total of nine bits corresponding to any single transfer from one DQ pin of each of the nine memory components 22 in the rank 24 is part of one 72-bit quad word (including parity information). After the burst is completed, the next rank 24 is activated after satisfying the mandatory rank switching delay. In most cases, this delay (row-to-row delay, tRR) will be a single clock cycle, upon which the second rank 24 will commence its burst. All data are latched to the second domain in the latch array of the control circuitry 16 and nine bits (one from each memory IC component 22) are added to the corresponding nine bits originating from the first rank 24. After all eight ranks 24 have burst out their data, a quad word plus ECC can be formed by recombining the necessary bits using virtual-to-physical address translation of data stored in the latch array in the control circuitry 16. The latches effectively serve as buffers for the data received from the memory IC components 22. Each complete transfer of all bursts from all ranks 24, which in the example adds up to 4608 bits (512 Bytes including ECC), is temporarily held in the latches and then ordered or recombined into the quad words +ECC.

In the case of writing data from the host system to the storage device 10, the same sequence of transfers from sub-domains corresponding to transfers within the burst and domains corresponding to the ranks 24 is maintained.

The invention has been described so far with respect to using ×8 memory IC components 22 and a burst length of eight transactions per access. In this configuration each memory IC component 22 contributes sixty-four bits to each burst transaction of the array 20, which means that catastrophic failure of one component 22 results in the loss of sixty-four bits of data that need to be corrected. Using standard ECC mechanisms, one bit per sixty-four bits of data is correctable if the total transfer is seventy-two bits. Since the storage device 10 can be operated so that each memory IC component 22 only contributes one bit to each burst transaction, a minimum of seventy-two memory IC components 22 is able to achieve chip kill redundancy. As such, the number of correctable bits to correct the catastrophic failure of one of the components 22 equals the product of the width of the input/output path and burst length of the component 22. On this basis, it should be apparent that other configurations are possible as well. For example, it is possible to use ×4 memory IC components 22 and reduce the burst length to four from the default of eight transactions by using DDR3-SDRAM IC components 22 in “burst chop mode.” This results in each IC component 22 outputting or receiving only sixteen bits per read or write access, respectively. As a result, in order to achieve chip kill redundancy, only sixteen bits need to be correctable, which means that the smallest redundant array 20 can be as small as eighteen memory IC components 22. Alternatively, if the seventy-two component array size is maintained, the number of tolerable catastrophic failures increases to four memory IC components 22.

The IC components 22 of the mass storage device 10 preferably run at low frequency to minimize power consumption. In preferred embodiments of the invention, the storage device 10 uses DDR3-SDRAM IC components 22, which as known in the art are designed for transfer rates of 800 Mbps and higher. If, for example, a 6 Gbps SATA/SAS interface 14 is used to interface with a host system, it would be of no practical value to increase the maximally sustainable bandwidth between the memory array 20 and the controller beyond the same 6 Gbps interface bandwidth to the host system. For a 64-bit wide interface 14 (plus ECC), the data rate at which the memory array 20 saturates the interface 14 is approximately 94 Mbps. In preferred embodiments, the memory array 20 is configured as a double-sided dual channel array, which increases the effective memory interface width to 128 bits (plus ECC). Accordingly, the DDR3 core frequency only needs to be at 23.5 MHz for fully utilizing the available host interface bandwidth. It is understood that memory arrays as described here are not necessarily operating at 100% bus efficiency. Therefore it can be desirable to add additional headroom by increasing the operating frequency of the DDR3-SDRAM components 22. Assuming 60% efficiency in memory bandwidth usage caused by row to row delays and similar other latencies, this is believed to raise the memory target frequency to approximately 40 MHz.

The low-frequency operation desired for the IC components 22 used in the storage device 10 can be achieved by turning off an internal digital delay lock loop (DLL) built into DDR3 SDRAM IC components 22, so that data are synchronized to strobe signals only. The DLL of these memory IC components synchronize the different areas of the die to the same clock signal. Though digital DLLs have a relatively limited operating range, it is possible to turn off the DLL during memory component initialization using a mode register set entry to run the DDR3 SDRAM IC components 22 outside the frequency range supported by the DLL. An external differential clock signal can be supplied to the IC components 22 via the CK and CK# pins and input and output signals are aligned with the differential strobes according to the DDR3 specifications.

Internally, the control circuitry 16 interfaces with a decode block which decodes the host system requests (packets) and subsequently communicates with a microprocessor, a nonlimiting example of which is a MicroBlaze SoftCore processor, through a buffer. The microprocessor performs ancillary functions of the storage device 10, for example, speed or retry negotiations and other house-keeping functions. The interface of the microprocessor is a fully synchronous processor local bus (PLB) designed for a single clock source for all master and slave devices in the host system. The decode block also interfaces with the memory controller on demand by the host system. Transferred packets can contain commands or data, wherein the contents are identified by a header. In case the packets contain commands, they are forwarded to the microprocessor, whereas actual data received from the host system are sent to a memory controller interface. The routing of data to two different destinations would cause a problem with respect to the clock domains. That is, the control and house-keeping data need to be clock and phase aligned with the PLB clock, whereas storage-bound data are time-critical and synchronized with the host interface. Moreover, the data buffer needs to run at the same clock as the memory array 20 which may or may not run at the same frequency as the PLB clock. In addition, the two control and data clocks are generated independent from each other which, even if they were at the same frequency, would cause phase misalignment.

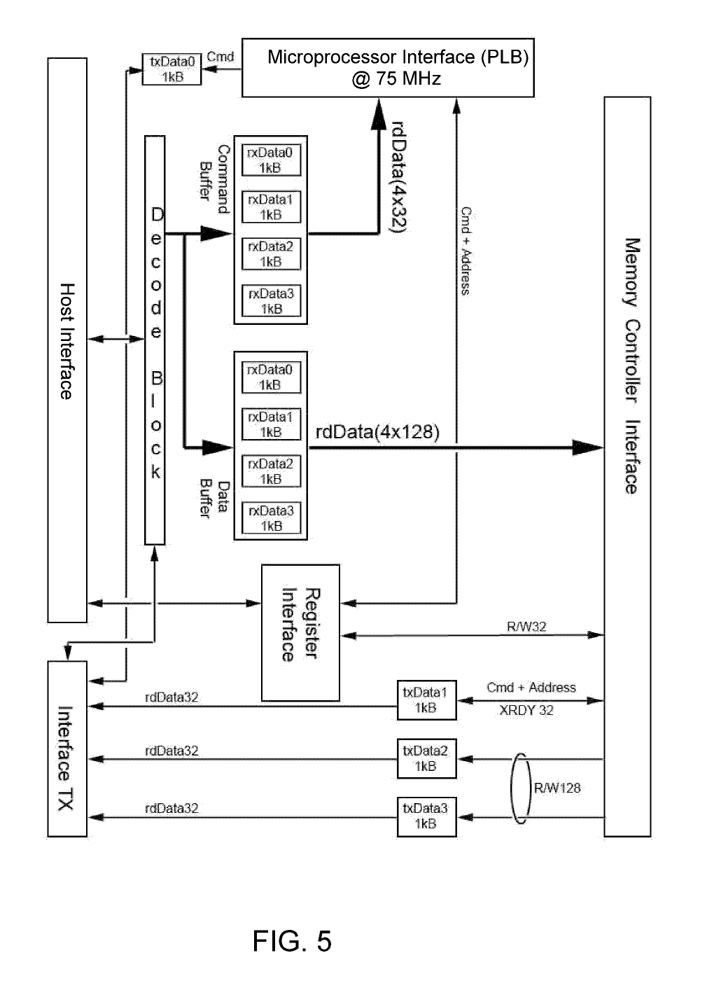

In view of the above, another aspect of the invention is to circumvent the mismatch and phase skew between the two different clock domains that interfere with the PLB functionality by shadowing the data between two buffers, one designated in FIG. 5 as a command buffer that runs synchronous with the microprocessor, and a data buffer that serves as the buffer to the memory controller interface, thereby completely decoupling the two clock domains within the logic of the interface card. As represented in the embodiment of FIG. 5, packets from the host system received via a host interface are decoded in the decode block and then distributed to the data buffer, which in this nonlimiting example is represented as an array of four rxData buffers with a density of 1024 Bytes (1 kB), with an additional 24 Bytes for the header (not shown). The decoder block also sends copies of the data to the command buffer, which in FIG. 5 is represented as duplicating the rxData buffers. Shadowing the data into the two independent data and command buffers provides complete independence of single clock-synchronous housekeeping and system signals from “on-demand” host and storage signals, thereby allowing for operating the storage memory array 20 at any suitable frequency and without phase-aligning the memory clock to the PLB clock.

The command buffer is represented in FIG. 5 as interfacing with the PLB of the processor through four 32-bit wide data paths, whereas the data buffer connects to the memory controller interface through four 128-bit data interfaces. In one embodiment of the invention, the interfaces define wide “composite” parallel buses (128-bit and 512-bit wide, respectively). However, it is also foreseeable to employ time-multiplexing of the data over narrower interfaces, for example using a single 32-bit or 128-bit bus interface in combination with a quad-pumped (quad data rate, QDR) bus protocol. In this case, an additional register could prefetch each 128-bit wide data slice from one of the IC components of the data buffer and then transfer the different slices to the memory controller. Other interfaces are also possible, for example a narrow, high speed interface similar to Rambus XDR2 interface could be employed to simplify trace routing.

While the invention has been described in terms of specific embodiments, it is apparent that other forms could be adopted by one skilled in the art. For example other types of memory IC components may emerge with future technologies. Moreover, alternative bus technologies, for example, time-division or wavelength multiplexing of memory data, may greatly simplify the layout of the circuit board 12 to allow for a single-rank configuration of the full width of the array 20. Therefore, the scope of the invention is to be limited only by the following claims.

1. A solid-state mass storage device adapted for use in a computer system and for storing data thereof, the storage device comprising:
a substrate on which is mounted a system interface, a control circuitry, and a plurality of substantially identical random access memory components that define at least one memory array, each of the memory components of the memory array having associated therewith an input/output path, a width of the input/output path, and a burst length; and
means using parity information for providing redundancy data sufficient to correct a catastrophic failure of one of the memory components of the memory array, a number of correctable bits to correct the catastrophic failure of one of the memory components equaling the product of the width of the input/output path thereof and the burst length thereof.

2. The storage device of claim 1, wherein the memory components are DDR3 SDRAM memory components.

3. The storage device of claim 2, wherein the means using parity information for providing redundancy data uses one bit of parity information for eight bits of data.

4. The storage device of claim 3, wherein the width of the input/output path of the memory components is ×8, the burst length is eight transactions, and the memory array contains seventy-two of the memory components.

5. The storage device of claim 4, wherein a read/write request to the memory components results in the transaction of 512 Bytes of data including the parity information.

6. The storage device of claim 5, the data are logically arranged in a buffer into a plurality of quad words plus parity information, and each of the quad words plus parity information is composed of a single bit from each of the memory components.

7. The storage device of claim 2 where the width of the input/output path of the memory components is ×4.

8. The storage device of claim 7, wherein the memory components are configured to operate in burst-chop mode, the memory array comprises eighteen of the memory components, each data set of sixteen bits is protected by two parity bits, and none of the memory components contributes more than one bit to each data plus parity set.

9. The storage device of claim 8, further comprising more than one of the memory arrays that are combined to a super-array capable of correcting multiple catastrophic failures of the memory components in the memory arrays.

10. The storage device of claim 9, wherein the means using parity information for providing redundancy data uses distributed parity and the parity information from one of the memory arrays are stored on parity memory components of the memory components of another of the memory arrays.

11. A method for storing and accessing data from a host computer, the method comprising:
connecting a mass storage device to the host computer, the mass storage device comprising a substrate on which is mounted a system interface, a control circuitry, and a plurality of substantially identical random access memory components that define at least one memory array, each of the memory components of the memory array having associated therewith an input/output path, a width of the input/output path, and a burst length; and
using parity information to provide redundancy data sufficient to correct a catastrophic failure of one of the memory components of the memory array, a number of correctable bits to correct the catastrophic failure of one of the memory components equaling the product of the width of the input/output path thereof and the burst length thereof.

12. The method of claim 11, wherein the memory components are DDR3 SDRAM memory components.

13. The method of claim 12, wherein the using step comprises using one bit of parity information for eight bits of data.

14. The method of claim 13, wherein the width of the input/output path of the memory components is ×8, the burst length is eight transactions, and the memory array contains seventy-two of the memory components.

15. The method of claim 14, wherein a read/write request to the memory components results in the transaction of 512 Bytes of data including the parity information.

16. The method of claim 15, wherein the data are logically arranged in a buffer into a plurality of quad words plus parity information, and each of the quad words plus parity information is composed of a single bit from each of the memory components.

17. The method of claim 12, wherein the width of the input/output path of the memory components is ×4.

18. The method of claim 17, wherein the memory components are operating in burst-chop mode, the memory array comprises eighteen of the memory components, each data set of sixteen bits is protected by two parity bits, and none of the memory components contributes more than one bit to each data plus parity set.

19. The method of claim 18, wherein more than one of the memory arrays are combined to a super-array that corrects multiple catastrophic failures of the memory components in the memory arrays.

20. The method of claim 19, wherein the using step comprises uses distributed parity and the parity information from one of the memory arrays is stored on parity memory components of the memory components of another of the memory arrays.

21. A solid-state mass storage device adapted for use in a computer system and for storing data thereof, the storage device comprising:
a substrate on which is mounted a system interface, a control circuitry, and a plurality of substantially identical random access memory components organized in ranks that define at least one memory array, each of the memory components of the memory array having associated therewith an input/output path, a width of the input/output path, and a burst length;
the storage device using sets of data equaling in size the product of the number of memory components, the input/output width of the memory components and the burst length of the memory components;
the sum of bits of a single transfer of data from a single I/O of each memory comprising a subset of data including redundancy data;
the redundancy data being sufficient to correct a catastrophic failure of one of the memory components of the memory array; and,
a number of correctable bits to correct the catastrophic failure of one of the memory components equaling the product of the width of the input/output path thereof and the burst length thereof.

22. The storage device of claim 21, wherein the memory components are DDR3 SDRAM memory components.

23. The storage device of claim 22, wherein the means using parity information for providing redundancy data uses one bit of parity information for eight bits of data.

24. The storage device of claim 23, wherein the width of the input/output path of the memory components is ×8, the burst length is eight transactions, and the memory array contains seventy-two of the memory components.

25. The storage device of claim 24, wherein a read/write request to the memory components results in the transaction of 512 Bytes of data including the parity information.

26. The storage device of claim 25, the data are logically arranged in a buffer into a plurality of quad words plus parity information, and each of the quad words plus parity information is composed of a single bit from each of the memory components.

27. The storage device of claim 22 where the width of the input/output path of the memory components is ×4.

28. The storage device of claim 27, wherein the memory components are configured to operate in burst-chop mode, the memory array comprises eighteen of the memory components, each data set of sixteen bits is protected by two parity bits, and none of the memory components contributes more than one bit to each data plus parity set.

29. The storage device of claim 28, further comprising more than one of the memory arrays that are combined to a super-array capable of correcting multiple catastrophic failures of the memory components in the memory arrays.

30. The storage device of claim 29, wherein the means using parity information for providing redundancy data uses distributed parity and the parity information from one of the memory arrays are stored on parity memory components of the memory components of another of the memory arrays.
